(19) United States
(12) Patent Application Publication
(10) Pub. No.: US 2021/0366322 A1
(43) Pub. Date: Nov. 25, 2021

(54) NOVEL DESKTOP ADVERTISING DISPLAY

(71) Applicant: Shenzhen Friday Originality Technology., Ltd., Shenzhen City (CN)

(72) Inventor: Youfen HU, Shenzhen (CN)

(21) Appl. No.: 16/629,136

(22) PCT Filed: Jan. 23, 2018
(86) PCT No.: PCT/CN2018/073739

§ 371 Date: Jan. 7, 2020

(51) Int. Cl. G09F 19/00; G09F 15/00; H04M 1/04

(52) U.S. Cl. CPC G09F 19/00; H04M 1/04; G09F 15/0018

(57) ABSTRACT

A novel desktop advertising displayer includes a displayer body, a cell, a main control panel arranged in the displayer body and to which the cell is electrically connected, and a mobile phone holder including a first side plate, a second side plate and a bottom plate, with a first gap is reserved between the first side plate and the second side plate. The displayer body is provided with a power output interface electrically connected to the main control panel. Users can place a mobile terminal on the mobile phone holder when charging the mobile terminal via the novel desktop advertising displayer, to prevent the mobile terminal from being stained by oil dirt on a desktop, so that user experience is improved. A lock plate is arranged to prevent the displayer body from falling or being stolen, and an infrared sensor is arranged to save electric energy.

### CROSS-REFERENCE TO RELATED APPLICATIONS

The present application is a National Stage Application of PCT International Application No. PCT/CN2018/073739 (filed on Jan. 23, 2018), under 35 U.S.C. § 371, which is hereby incorporated by reference in its complete entirety.

### TECHNICAL FIELD

The invention relates to the technical field of advertisement terminal equipment, in particular, to a novel desktop advertising displayer.

### DESCRIPTION OF RELATED ART

Chinese Utility Model Patent Application No. 201621140179.1 discloses a desktop advertising displayer which comprises a displayer body and a power output module arranged in the displayer body and further comprises at least one charging wire and at least one reception board mounted on the displayer body, wherein the charging wire is electrically connected to the power output module, and the reception board is provided with a wire slot allowing the charging wire to be received therein. The desktop advertising displayer eliminates the trouble of carrying a charging wire for users, but still needs to be improved. For example, when users charge a to-be-charged mobile terminal by means of the desktop advertising displayer, the mobile terminal has to be placed on a desktop and may be stained by much oil dirt on the desktop in a dining hall, which severely affects user experience.

### BRIEF SUMMARY OF INVENTION

The technical issue to be settled by the invention is to provide a novel desktop advertising displayer having good user experience.

The technical solution adopted by the invention to settle the above technical issue is as follows: the novel desktop advertising displayer comprises a displayer body, and a cell and a main control panel arranged in the displayer body, wherein the cell is electrically connected to the main control panel, and the displayer body is provided with a power output interface electrically connected to the main control panel and a mobile phone holder including a first side plate, a second side plate and a bottom plate, the first side plate and the second side plate are connected to the bottom plate, are parallel to each other and are located on the same side of the bottom plate, and a first gap is reserved between the first side plate and the second side plate.

Furthermore, the height of the first side plate is smaller than that of the second side plate.

Furthermore, the mobile phone holder further includes a third side plate connected to the bottom plate, the third side plate and the second side plate are parallel to each other and are located on the same side of the bottom plate, the third side plate is located on a side, away from the first side plate, of the second side plate, and a second gap is reserved between the third side plate and the second side plate.

Furthermore, an anti-slip mat is arranged on a side, close to the second side plate, of the bottom plate.

Furthermore, the mobile phone holder is detachably connected to the displayer body.

Furthermore, a buckle site is arranged at the top of the displayer body, and a buckle matched with the buckle site is arranged on the mobile phone holder.

Furthermore, the buckle comprises a first clamping plate and a second clamping plate which are connected to the bottom plate, wherein the first clamping plate and the second clamping plate are parallelly arranged in a spaced manner and are located on a side, away from the first side plate, of the bottom plate.

Furthermore, the novel desktop advertising displayer further comprises an infrared sensor arranged on the displayer body and electrically connected to the main control panel.

Furthermore, the novel desktop advertising displayer further comprises a lock plate provided with a plurality of lock pieces, lock slots matched with the lock pieces are formed in the bottom of the displayer body, and the lock pieces are located in the lock slots and are able to move in the lengthwise direction of the lock slots.

Furthermore, the lock plate is formed with a lock hole, and a limiting part is arranged in the lock hole and is used for limiting the displayer body to prevent the lock pieces from disengaging from the lock slots.

The invention has the following beneficial effects: the novel desktop advertising displayer is provided with a mobile phone holder, and users can place a mobile terminal on the mobile phone holder when charging the mobile terminal by means of the novel desktop advertising displayer, to prevent the mobile terminal from being stained by oil dirt on a desktop, so that user experience is improved; and the novel desktop advertising displayer is simple in structure and low in manufacturing cost, and the size of the novel desktop advertising displayer is not increased.

### DRAWINGS

FIG. 1 is an overall structural diagram of a novel desktop advertising displayer in Embodiment 1 of the invention;

FIG. 2 is an exploded view of the novel desktop advertising displayer in Embodiment 1 of the invention;

FIG. 3 is a structural diagram of a lock plate of the novel desktop advertising displayer in Embodiment 1 of the invention; and

FIG. 4 is a structural diagram of a displayer body of the novel desktop advertising displayer in Embodiment 1 of the invention.

### DETAILED DESCRIPTION OF THE INVENTION

The key concept of the invention lies in that a mobile phone holder is additionally arranged on a displayer body of a desktop advertising displayer and a first gap for receiving a mobile terminal is formed by first and second side plates and a bottom plate.

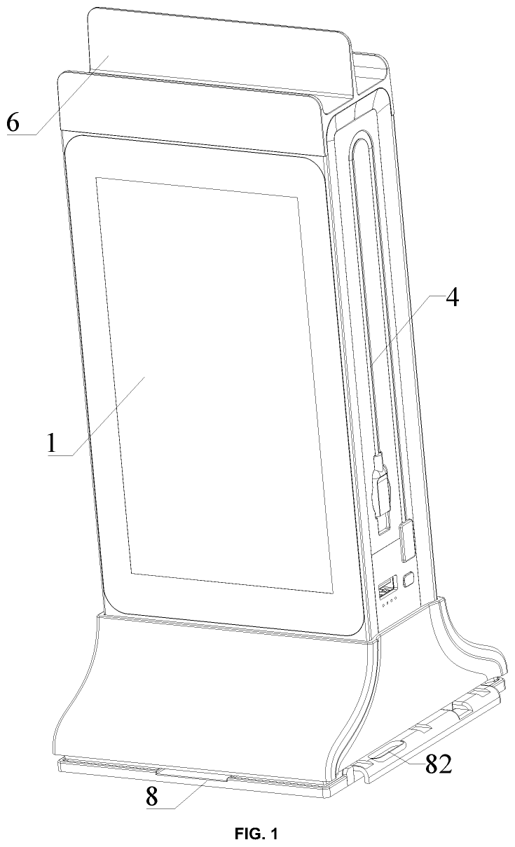

Referring to FIG. 1-FIG. 4, a novel desktop advertising displayer comprises a displayer body 1, and cells 2 and a main control panel 3 arranged in the displayer body 1, wherein the cells 2 are electrically connected to the main control panel 3, the displayer body 1 is provided with a power output interface electrically connected to the main control panel 3 and a mobile phone holder 6 including a first side plate 61, a second side plate 62 and a bottom plate 64, the first side plate 61 and the second side plate 62 are connected to the bottom plate 64, are parallel to each other, and are located on the same side of the bottom plate 64, and a first gap is reserved between the first side plate 61 and the second side plate 62.

The structure/principle of the invention is as follows: when a user charges a mobile terminal by means of the novel desktop advertising displayer, the user can place the mobile terminal into the first gap of the mobile phone holder 6, so that the mobile terminal is prevented from being stained by dirt on a desktop. Of course, the user can also place the mobile terminal on the mobile phone holder 6 of the desktop advertising displayer when using the mobile terminal (for example, for watching videos) to set both hands free.

From the above description, the invention has the following beneficial effects: the displayer body of the novel desktop advertising displayer is provided with the mobile phone holder, and the user can place the mobile terminal on the mobile phone holder when charging the mobile terminal by means of the novel desktop advertising displayer, to prevent the mobile terminal from being stained by oil dirt on the desktop, so that user experience is improved; and the novel desktop advertising displayer is simple in structure and low in manufacturing cost, and the size of the novel desktop advertising displayer is not increased.

Furthermore, the height of the first side plate 61 is smaller than that of the second side plate 62.

From the above description, the height of the first side plate is smaller than that of the second side plate, so that the situation where an image displayed by the mobile terminal is blocked by the first side plate is prevented.

Furthermore, the mobile phone holder 6 further includes a third side plate 63 connected to the bottom plate 64, wherein the third side plate 63 and the second side plate 62 are parallel to each other and are located on the same side of the bottom plate 64, the third side plate 63 is located on a side, away from the first side plate 61, of the second side plate 62, and a second gap is reserved between the third side plate 63 and the second side plate 62.

From the above description, two mobile terminals can be placed on the mobile phone holder, so that the usage value of the novel desktop advertising displayer is further improved. Similarly, the height of the third side plate is preferably smaller than that of the second side plate.

Furthermore, an anti-slip mat is arranged on a side, close to the second side plate 62, of the bottom plate 64.

From the above description, the anti-slip mat is arranged on the bottom plate, so that the mobile terminal of the user is prevented from being scratched by the mobile phone holder, and the friction between the mobile phone holder and the mobile terminal of the user is increased to prevent the mobile phone from falling off from the mobile phone holder.

Furthermore, the mobile phone holder 6 is detachably connected to the displayer body 1.

From the above description, the mobile phone holder is connected to the displayer body in a screwed, clamped or glued manner.

Furthermore, a buckle site 7 is arranged at the top of the displayer body 1, and a buckle matched with the buckle site 7 is arranged on the mobile phone holder 6.

Furthermore, the buckle comprises a first clamping plate 65 and a second clamping plate 66 which are connected to the bottom plate 64, wherein the first clamping plate 65 and the second clamping plate 66 are parallelly arranged in a spaced manner and are located on a side, away from the first side plate 61, of the bottom plate 64.

From the above description, the mobile phone holder and the displayer body can be connected, assembled and disassembled easily.

Furthermore, the novel desktop advertising displayer further comprises an infrared sensor arranged on the displayer body 1 and electrically connected to the main control panel 3.

From the above description, the infrared sensor is a body induction device, so that the novel desktop advertising displayer will not start to work to display an image until a person approaches the novel desktop advertising displayer; and when sensing through the infrared sensor that no person is around the novel desktop advertising displayer, the novel desktop advertising displayer stops working, so that electric energy is saved, and waste of resources is reduced.

Furthermore, the novel desktop advertising displayer further comprises a lock plate 8 provided with a plurality of lock pieces 81, lock slots 9 matched with the lock pieces 81 are formed in the bottom of the displayer body 1, and the lock pieces 81 are located in the lock slots 9 and are able to move in the lengthwise direction of the lock slots 9.

From the above description, the lock plate which can be fastened on an external component (such as the desktop) is arranged to fix the displayer body, so that the displayer body is prevented from falling down.

Furthermore, the lock plate 8 is formed with a lock hole 82, and a limiting part is arranged in the lock hole 82 and is used for limiting the displayer body 1 to prevent the lock pieces 81 from disengaging from the lock slots 9.

From the above description, the limiting part may be a padlock by which the owner limits the displayer body on the lock plate to prevent the displayer body from getting lost.

### Embodiment 1

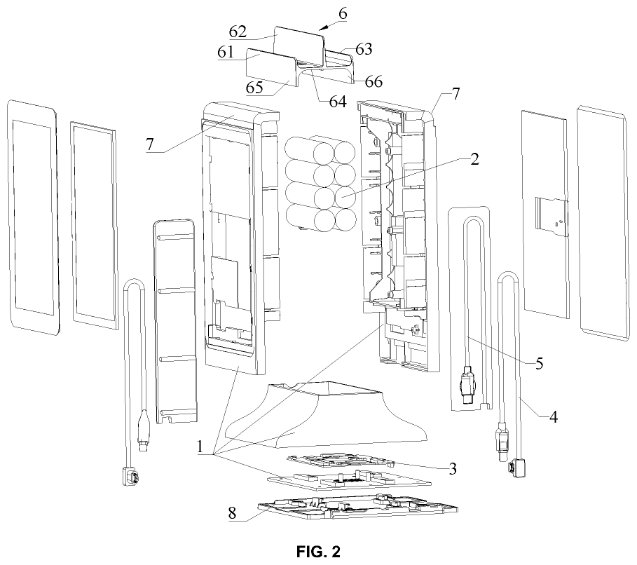

Referring to FIG. 1-FIG. 4, in Embodiment 1 of the invention, the novel desktop advertising displayer, as shown in FIG. 1 and FIG. 2, comprises a displayer body 1, and cells 2 and a main control panel 3 arranged in the displayer body 1, wherein the cells 2 are electrically connected to the main control panel 3, and the displayer body 1 is provided with a power output interface electrically connected to the main control panel 3. Optionally, the novel desktop advertising displayer further comprises a charging wire 4 electrically connected to the power output interface, a wire slot 5 used for receiving the charging wire 4 is formed in at least one side wall of the displayer body 1, and the length of the charging wire 4 is greater than the height of the displayer body 1. Preferably, a plurality of wire clips (not shown) are arranged in the wire slot 5 and are used for preventing unexpected disengagement of the charging wire 4 from the wire slot 5, that is, the charging wire 4 can be better received in the wire slot 5.

The displayer body 1 is provided with a mobile phone holder 6 including a first side plate 61, a second side plate 62 and a bottom plate 64, wherein the first side plate 61 and the second side plate 62 are connected to the bottom plate 64, are parallel to each other, and are located on the same side of the bottom plate 64, and a first gap is reserved between the first side plate 61 and the second side plate 62 to receive a mobile phone of a user. Preferably, the height of the first side plate 61 is smaller than that of the second side plate 62.

Optionally, the mobile phone holder 6 further includes a third side plate 63 connected to the bottom plate 64, the third side plate 63 and the second side plate 62 are parallel to each other and are located on the same side of the bottom plate 64, the third side plate 63 is located on a side, away from the first side plate 61, of the second side plate 62, and a second gap is reserved between the third side plate 63 and the second side plate 62.

Optionally, an anti-slip mat (not shown) is arranged on a side, close to the second side plate 62, of the bottom plate 64.

The mobile phone holder 6 is detachably connected to the displayer body 1 in a manner such as, but not limited to, a threaded manner, a screwed manner, a buckled manner, or a glued manner.

In this embodiment, a buckle site 7 is arranged at the top of the displayer body 1, and a buckle matched with the buckle site 7 is arranged on the mobile phone holder 6.

As shown in FIG. 2, the buckle particularly comprises a first clamping plate 65 and a second clamping plate 66 which are connected to the bottom plate 64, wherein the first clamping plate 65 and the second clamping plate 66 are parallelly arranged in a spaced manner and are located on a side, away from the first side plate 61, of the bottom plate 64. Preferably, the first side plate 61, the second side plate 62, the bottom plate 64, the first clamping plate 65 and the second clamping plate 66 form an H-shape rotated by 90°, so that when the mobile phone holder 6 like a clip is to be assembled on the displayer body 1 by the user, the user just needs to press the first side plate and the second side plate with two fingers to increase the distance between the first clamping plate and the second clamping plate to allow the mobile phone holder 6 to be clamped into the buckle site 7 of the displayer body 1 more easily.

To save energy, the novel desktop advertising displayer in this embodiment further comprises a body induction device. In particularly, the novel desktop advertising displayer in this embodiment further comprises an infrared sensor (not shown) arranged on the displayer body 1 and electrically connected to the main control panel 3.

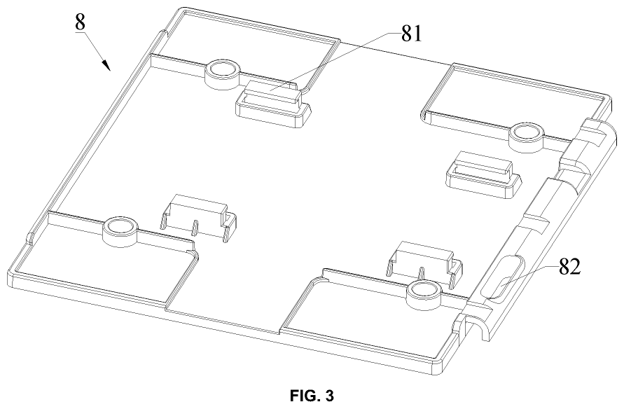

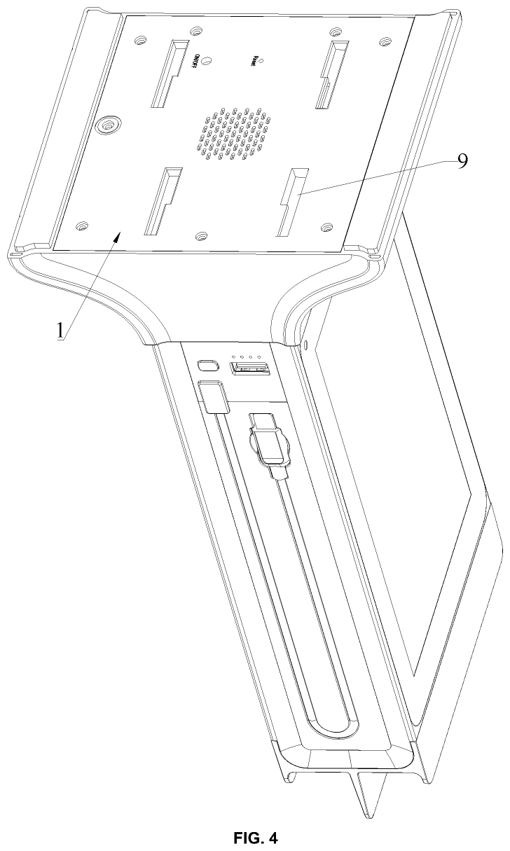

Referring to FIG. 1, FIG. 3 and FIG. 4, to prevent the novel desktop advertising displayer against accidental falling, the novel desktop advertising displayer further comprises a lock plate 8 provided with a plurality of lock pieces 81, lock slots 9 matched with the lock pieces 81 are formed in the bottom of the displayer body 1, and the lock pieces 81 are located in the lock slots 9 and are able to move in the lengthwise direction of the lock slots 9. In this embodiment, the lock pieces 81 are in an inverted L shape.

Referring to FIG. 1 and FIG. 3, to prevent the novel desktop advertising displayer from being stolen, the lock plate 8 is formed with a lock hole 82, and a limiting part is arranged in the lock hole 82 and is used for limiting the displayer body 1 to prevent the lock pieces 81 from disengaging from the lock slots 9. Preferably, the limiting part is a padlock. After the owner places the padlock into the lock hole 82, an unlocking path of the displayer body 1 is blocked by the padlock to prevent the displayer body 1 from being completely separated from the lock plate 8, so that novel desktop advertising displayer is prevented from being stolen.

To sum up, the novel desktop advertising displayer of the invention is provided with the mobile phone holder, and users can place a mobile terminal on the mobile phone holder when charging the mobile terminal by means of the novel desktop advertising displayer, to prevent the mobile terminal from being stained by oil dirt on the desktop, so that user experience is improved; the novel desktop advertising displayer is simple in structure and low in manufacturing cost, and the size of the novel desktop advertising displayer is not increased; the lock plate is arranged to prevent the displayer body from falling down or being stolen; and the infrared sensor is arranged to save electric energy.

### REFERENCE SYMBOLS

1 displayer body
2 cell
3 main control panel
4 charging wire
5 wire slot
6 mobile phone holder
61 first side plate
62 second side plate
63 third side plate
64 bottom plate
65 first clamping plate
66 second clamping plate
7 buckle site
8 lock plate
81 lock piece
82 lock hole
9 lock slot

What is claimed is:

1. A novel desktop advertising displayer, comprising a displayer body, and a cell and a main control panel arranged in the displayer body, wherein the cell is electrically connected to the main control panel, and the displayer body is provided with a power output interface electrically connected to the main control panel; and the displayer body is provided with a mobile phone holder including a first side plate, a second side plate and a bottom plate, the first side plate and the second side plate are connected to the bottom plate, are parallel to each other and are located on a same side of the bottom plate, and a first gap is reserved between the first side plate and the second side plate.

2. The novel desktop advertising displayer according to claim 1, wherein a height of the first side plate is smaller than that of the second side plate.

3. The novel desktop advertising displayer according to claim 1, wherein the mobile phone holder further includes a third side plate connected to the bottom plate, the third side plate and the second side plate are parallel to each other and are located on a same side of the bottom plate, the third side plate is located on a side, away from the first side plate, of the second side plate, and a second gap is reserved between the third side plate and the second side plate.

4. The novel desktop advertising displayer according to claim 1, wherein an anti-slip mat is arranged on a side, close to the second side plate, of the bottom plate.

5. The novel desktop advertising displayer according to claim 1, wherein the mobile phone holder is detachably connected to the displayer body.

6. The novel desktop advertising displayer according to claim 5, wherein a buckle site is arranged at a top of the displayer body, and a buckle matched with the buckle site is arranged on the mobile phone holder.

7. The novel desktop advertising displayer according to claim 6, wherein the buckle comprises a first clamping plate and a second clamping plate which are connected to the bottom plate, and the first clamping plate and the second clamping plate are parallelly arranged in a spaced manner and are located on a side, away from the first side plate, of the bottom plate.

8. The novel desktop advertising displayer according to claim 1, further comprising an infrared sensor arranged on the displayer body and electrically connected to the main control panel.

9. The novel desktop advertising displayer according to claim 1, further comprising a lock plate, wherein the lock plate is provided with a plurality of lock pieces, lock slots matched with the lock pieces are formed in a bottom of the displayer body, and the lock pieces are located in the lock slots and are able to move in a lengthwise direction of the lock slots.

10. The novel desktop advertising displayer according to claim 9, wherein the lock plate is formed with a lock hole, a limiting part is arranged in the lock hole and is used for limiting the displayer body to prevent the lock pieces from disengaging from the lock slots.
